(19) United States
(12) Patent Application Publication
(10) Pub. No.: US 2008/0258580 A1
(43) Pub. Date: Oct. 23, 2008

(54) Reliability Improvement For Piezoelectric Imaging Array Device

(76) Inventors: John K. Schneider, Snyder, NY (US); Jack C. Kitchens, Tonawanda, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 12/106,952

(22) Filed: Apr. 21, 2008

Related U.S. Application Data
(60) Provisional application No. 60/913,044, filed on Apr. 20, 2007.

(51) Int. Cl. H02N 2/00

(52) U.S. Cl. 310/334

(57) ABSTRACT

A device for scanning a biological object, such as a fingerprint, is disclosed. One such device includes an array of acoustic waveguides and a piezoelectric array device. The piezoelectric array devices may be arranged in association with the waveguide array to provide ultrasonic energy in the form of an ultrasonic wave or collection of waves to the waveguide array, and also arranged to receive ultrasonic energy in the form of an ultrasonic wave or collection of waves from the waveguide array. The acoustic energy received by the piezoelectric array from the waveguide array may be energy that has been reflected from the biological object. A waveguide array according to the invention uses internal reflection to transmit the acoustic wave from one end of the waveguide array to another end of the waveguide array.

### CROSS-REFERENCE TO RELATED APPLICATION

This application claims the benefit of priority to U.S. provisional patent application Ser. No. 60/913,044, filed on Apr. 20, 2007.

### FIELD OF THE INVENTION

The present invention relates to improving the reliability and image quality of a semiconductor imaging device, such as a thin film transistor (“TFT”) piezoelectric imaging device. TFT's have been used in fingerprint imaging devices to gather information which can be provided to a computer, which in turn can create an image of the fingerprint.

### BACKGROUND OF THE INVENTION

Although excellent in imaging ability, semiconductor and/or TFT type piezoelectric imaging devices used for fingerprint readers are subject to short life expectancies. When a person presents a finger for imaging, electrostatic shock, impact, abrasion and other deleterious effects are exacted on the imaging device, causing damage to the imaging device. Consequently, many prior art semiconductor and/or TFT piezoelectric imaging devices stop operating soon after installation.

To extend the life of such devices, the prior art teaches applying insulating materials over the top of the imaging devices, thereby protecting the imaging devices. The prior art insulating materials provide a physical barrier or static shorting barrier. However, such insulating materials reduce the quality of the images produced. Prior art semiconductor or TFT imaging devices that have an insulting material produce blurrier images than those that do not have the insulting material. Therefore, in order to use a sensitive device like a semiconductor or TFT for reading a biological object, such as a fingerprint, an improved protective device is needed.

### SUMMARY OF THE INVENTION

The invention may be embodied as a device for scanning a biological object, such as a fingerprint. One such device includes an array of acoustic waveguides and a piezoelectric array device. The piezoelectric array devices may be arranged in association with the waveguide array to provide ultrasonic energy in the form of an ultrasonic wave or collection of waves to the waveguide array, and also arranged to receive ultrasonic energy in the form of an ultrasonic wave or collection of waves from the waveguide array. The acoustic energy received by the piezoelectric array from the waveguide array may be energy that has been reflected from the biological object. A waveguide array according to the invention uses internal reflection to transmit the acoustic wave from one end of the waveguide array to another end of the waveguide array.

The waveguide array may serve as a platen on which the biological object is placed during scanning. An acoustic coupling media may be disposed between the waveguide array and the piezoelectric array in order to facilitate transmission of the acoustic energy traveling between the waveguide array and the piezoelectric array.

The waveguides of the waveguide array may have a cladding and a core. A suitable cladding material may be polymethylmethacrylate. A suitable core material may be polystyrene.

Another suitable cladding material may be polyethylene. A suitable core material may be polycarbonate.

A device according to the invention may have the piezoelectric array device, which is capable of providing ultrasonic energy in the form of an ultrasonic wave or collection of ultrasonic waves, and which is capable of receiving reflected ultrasonic energy in the form of a reflected ultrasonic wave or collection of ultrasonic waves. An array of waveguides may be arranged in association with the piezoelectric array device to receive ultrasonic energy from the piezoelectric array device, transmit the ultrasonic energy to a biological object, receive ultrasonic energy reflected from the biological object, and transmit the reflected ultrasonic energy to the piezoelectric device, where the energy received at the piezoelectric device is provided as signals to a computer. The computer may have software running thereon which interprets the signals and provides an image of the biological object on a monitor.

### BRIEF DESCRIPTION OF THE DRAWINGS

For a fuller understanding of the nature and objects of the invention, reference should be made to the accompanying drawings and the subsequent description. Briefly, the drawings are:

FIG. 1 depicts a finger on a device according to the invention;

FIG. 2 depicts a top view of a waveguide array that may be used in a device according to the invention; and

FIG. 3 is a perspective view of a device according to the invention.

### FURTHER DESCRIPTION OF THE INVENTION

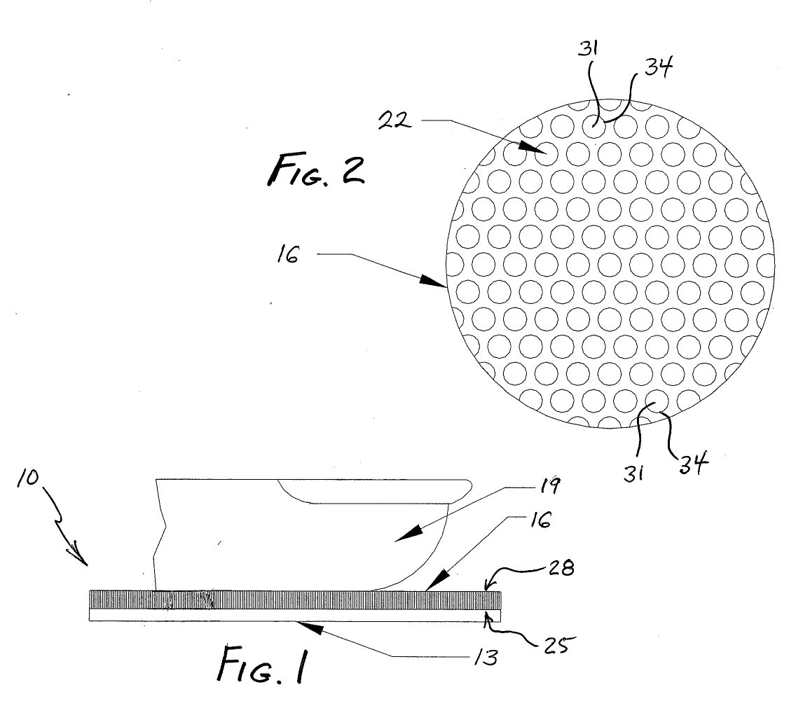

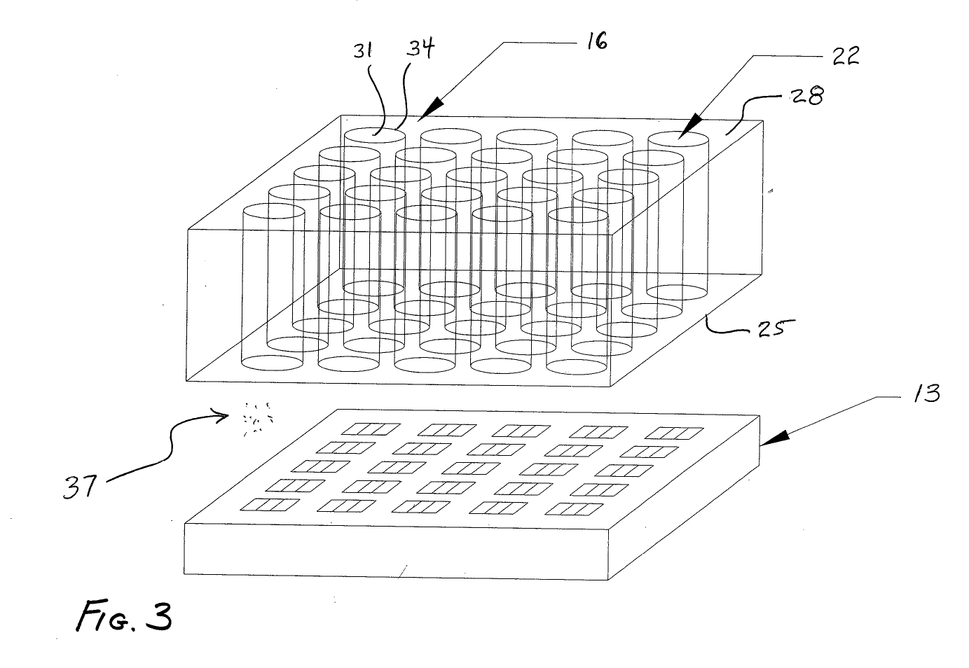

FIGS. 1, 2 and 3 depict a device according to the invention. The device depicted in FIGS. 1, 2 and 3 is a fingerprint scanner 10. In such a scanner 10 there may be an piezoelectric acoustic detector array 13 and an acoustic waveguide array 16. The word “acoustic” is used herein to refer to longitudinal waves, such as ultrasonic waves, even though such waves may not be audible by a human being. The detector array 13 may detect acoustic waves that have been reflected from a biological object, such as a finger. The detector array 13 may also produce acoustic waves, and in such a device the same array may be used to send acoustic waves toward a finger and also detect the waves reflected from the finger. The piezoelectric array 13 depicted in FIG. 3 includes an array of TFTs. The waveguide array 16 depicted in FIG. 3 insulates the piezoelectric array 13 from electro-static shock, mechanical shock and/or abrasion that might otherwise be present if the biological object were placed directly on the TFT.

In the device depicted in the figures, during operation an ultrasonic pulse that issues from the piezoelectric array device 13 is carried to the finger 19 by the acoustic waveguide array 16. The ultrasonic waves reflected from the finger 19 travel back via the same acoustic waveguide array 16. The reflected waves are detected by the piezoelectric array device 13.

The waveguide array 16 may be made from glass, plastic, ceramic or metallic materials. Details of the waveguide array 16 are provided below. Since the materials of the acoustic waveguide array 16 act for both electrostatic insulation and as a shock and abrasion barrier, the piezoelectric array device 16 is protected, and consequently its useful life is extended. However, unlike prior art insulators, the waveguide array 16 produces a much clearer image of the fingerprint.

The waveguide array 16 may be a bundle of substantially parallel acoustic waveguides 22 which are held together into a single assembly. Each waveguide 22 may be fused, bonded or otherwise held rigidly to adjacent waveguides 22. The waveguide array 16 may take the form of a plate, which can serve as a platen on which the biological object may be rested during the scanning process. The acoustic waveguides 22 may be fibers, and may be thought of as conduits that transmit acoustic energy from a first end of the waveguide 22 to a second end of the waveguide 22. Each waveguide 22 in the array 16 may be used to convey a different acoustic signal from one side of the array 16 to the other side. In order to preserve the information being transmitted by the waveguides 22, the relative positions of the first ends of each waveguide may be placed substantially in a first plane, and the relative positions of the second ends of each waveguide may be placed substantially in a second plane.

Each waveguide 22 may be constructed to have a core 31 and a cladding 34. The core 31 and cladding 34 are made from different materials so that the speed-of-sound in the core 31 is different from the speed-of-sound in the cladding 34. In this manner, an acoustic wave traveling through the waveguide 22 is substantially contained in the waveguide 22 by means of total internal reflection at the interface of the two different materials.

Since acoustic energy may be used to transmit information, information about a fingerprint may be transmitted via the waveguides 22 using ultrasonic energy pulses. The waveguide array 16 may be used to transmit information about a pattern (such as a fingerprint) from one side of the waveguide array 16 to another side of the waveguide array 16, without significant loss of the relative proportions of the pattern information.

The waveguide array 16 may be embodied as a polymer clad fiber, which can be considered to be an acoustic waveguide 22. Other materials, such as glass, metal or ceramic, may be used to clad the fiber. It will be recognized that there is a large number of core/cladding combinations that can be successfully be used for the invention. By carefully selecting the materials used for the core 31 and cladding 34, an acoustic wave traveling within the fiber is substantially confined to the core 31. The relative velocity of the shear wave properties of the cladding material must be greater than that in the core material. Under these conditions longitudinal or compression waves are allowed to propagate along the fiber length. This condition prevents leakage of the wave energy through the cladding 34. The greater the differences in shear velocities between the core 31 and cladding 34, the thinner the cladding 34 can be. When acoustic energy waves are confined primarily to the core 31, external conditions will have no significant effect upon the transmission of the acoustic waves, and therefore signal contamination (or loss) is minimized.

Although it would be an easy matter to simply select two materials with which to create a waveguide 22, the realities of manufacturing, chemistry and physics come into play. The materials selected for the core 31 and cladding 34 of an acoustic waveguide 22 may need to be similar with regard to the properties needed for manufacturing processing. For example, softening temperature, uniformity of extrusion, and the ability to extrude may be important considerations when choosing the materials for the core 31 and cladding 34.

In order to propagate through the waveguide 22, acoustic energy should have a wave length that is at or above a cutoff frequency. The cutoff frequency for the acoustic waveguide 22 can be determined by:

$${f}_{c} = \frac{{V}_{s}}{2 d}$$

where f_{c} is the cutoff frequency, Vₛ is the shear velocity (the velocity perpendicular to the longitudinal velocity vector) of the core and d is the diameter of the core 31.

In manufacturing an acoustic waveguide 22, suitable materials may be selected for the core 31 and cladding 34 of the waveguide 22. Based on the relative differences in shear wave propagation of the materials, the ratio of core diameter to the minimum cladding thickness may be determined. A cylinder of the core material may be prepared of a nominal diameter. Similarly, a hollow cylinder of the cladding material may be prepared with an inner diameter similar to that of the core 31 and an outer diameter proportional to the desired core-cladding ratio. These pre-forms of the core 31 and cladding 34 may be nested together and heated in an oven until they fuse. The core/cladding cylinders can then be drawn to the desired fiber diameter using standard fiber extrusion and drawing techniques. Such techniques are commonly used to manufacture poly-thread and fiber, such as monofilament fishing line.

Once the waveguide fiber is prepared, it may be cut into appropriate lengths, and carefully bundled with other waveguide fibers to create an array of substantially parallel fibers. At this point the fiber bundle may be heated to fuse the claddings 34 and exclude interstitial air or gases. Alternatively, the interstices between waveguides 22 may be filled in order to pot the waveguides 22 by using a suitable potting compound, such as a two part curing resin system (epoxy, RTV, etc.). Or the waveguides 22 may be mechanically constrained so that the ends 25, 28 of the waveguides 22 are not allowed to move. The end product should be an assembly of substantially parallel waveguides 22, each having a position that is fixed relative to the other waveguides 22 in the assembly.

At this point the acoustic waveguide bundle 16 may be cut perpendicular to the longitudinal axes of the fiber to provide a plate having a desired thickness. The end surfaces 25, 28 of the acoustic waveguides 22 may be polished to a suitable flatness to prevent diffraction losses of acoustic waves that enter and leave the waveguides 22.

One set of materials that may offer the qualities needed to create an acoustic waveguide 22 and ultimately and acoustic waveguide plate-array 16 may be Polymethylmethacrylate (PMMA)—optical grade—for the cladding 34 and polystyrene (PS)-grade GPPS for the core 31. However, it should be noted that many grades of PMMA may be used as the cladding 34—as long as the shear velocity of the cladding 34 is higher than the shear velocity of the core 31.

Another polymer pair that may be used is polyethylene and polycarbonate, although this pair may be more difficult to process because of melting points of these materials are not similar. These are only examples of the types of materials that may be used. Other polymer or copolymer pairs can successfully be used for the core 31 and the cladding 34 to create a suitable acoustic waveguide 22, and subsequently a coherent acoustic fiber plate array 16.

An acoustic plate waveguide array 16 may alternately be created by filling hollow capillaries of a capillary array with a suitable acoustic transmission resin, such as PMMA or polystyrene. The capillary array itself could be constructed of glass or synthetic plastic resin that may be of different acoustic properties than that of the core material.

The acoustic plate waveguide array 16 offers an inexpensive means of conveying acoustic energy information from one place to another with a minimum of signal loss and a maximum of physical compactness.

The plate waveguide array 16 may be used to transmit ultrasonic energy to a finger and/or from a finger as part of a system/method for producing a fingerprint image corresponding to the finger. In one such method, an acoustic plate waveguide array 16, such as that described above, may be provided. A finger may be placed proximate to the second ends 28 of the waveguides 22. Ultrasonic energy may be provided by the piezoelectric array to the first ends 25 of the waveguides 22, and travel through the waveguides 22 to the finger 19. Some of the energy provided to the finger 19 may be reflected toward the waveguides 22. The ultrasonic energy reflected from the finger may be received at the second ends 28 of the waveguides 22 and transmitted via the waveguides 22 to the first ends 25. The transmitted reflected energy may be provided from the first ends 25 of the waveguides 22 to the piezoelectric array 13. Output signals from the piezoelectric array 13 may be provided to a computer system, which has software suitable for interpreting the output signals and generating an image of the fingerprint on a monitor.

It should be noted that the waveguide array 16 may be placed in contact with the piezoelectric array 13 (see FIG. 1), or spaced apart from the piezoelectric array 13 (see FIG. 3). When the waveguide array 16 is spaced apart from the piezoelectric array 13 an acoustic coupling media 37 may be placed between the waveguide array 16 and the piezoelectric array 13 so as to facilitate transmission of the acoustic energy. For example, suitable acoustic coupling media 37 may include a fluid (such as mineral oil), gel (such as a water solution of agar agar, gelatin or a vinyl plastisol), or a solid (such as polystyrene or PMMA).

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A biological object scanner, comprising:
an array of acoustic waveguides;
a piezoelectric array device arranged in association with the waveguide array to provide ultrasonic energy in the form of an ultrasonic wave or collection of waves to the waveguide array, and to receive ultrasonic energy in the form of a reflected ultrasonic wave or collection of waves from the waveguide array.

2. The scanner of claim 1, wherein the waveguide array serves as a platen on which the biological object is placed during scanning.

3. The scanner of claim 1, further comprising an acoustic coupling media disposed between the waveguide array and the piezoelectric array.

4. The scanner of claim 1, wherein the piezoelectric array device includes a thin film transistor.

5. The scanner of claim 1, wherein the waveguide array is made from materials that insulate the piezoelectric array from electrostatic shock.

6. The scanner of claim 5, wherein the waveguide array has acoustic fibers, each with a cladding and a core.

7. The scanner of claim 6, wherein the cladding is polymethylmethacrylate.

8. The scanner of claim 7, wherein the core is polystyrene.

9. The scanner of claim 6, wherein the core is polystyrene.

10. The scanner of claim 6, wherein the cladding is polyethylene.

11. The scanner of claim 10, wherein the core is polycarbonate.

12. The scanner of claim 6, wherein the core is polycarbonate.

13. A biological object scanner, comprising:
a piezoelectric array device capable of providing ultrasonic energy in the form of an ultrasonic wave or collection of ultrasonic waves, and capable of receiving reflected ultrasonic energy in the form of a reflected ultrasonic wave or collection of ultrasonic waves;
an array of waveguides arranged in association with the piezoelectric array device to receive ultrasonic energy from the piezoelectric array device, transmit the ultrasonic energy to a biological object, receive ultrasonic energy reflected from the biological object, and transmit the reflected ultrasonic energy to the piezoelectric device.

14. The scanner of claim 13, wherein the waveguide array serves as a platen on which the biological object is placed during scanning.

15. The scanner of claim 13, further comprising an acoustic coupling media disposed between the waveguide array and the piezoelectric array.

16. The scanner of claim 13, wherein the piezoelectric array device includes a thin film transistor.

17. The scanner of claim 13, wherein the waveguide array is made from materials that insulate the piezoelectric array from electrostatic shock.

18. The scanner of claim 17, wherein the waveguide array has acoustic fibers, each with a cladding and a core.

19. The scanner of claim 18, wherein the cladding is polymethylmethacrylate.

20. The scanner of claim 19 wherein the core is polystyrene.

21. The scanner of claim 18, wherein the core is polystyrene.

22. The scanner of claim 18, wherein the cladding is polyethylene.

23. The scanner of claim 22, wherein the core is polycarbonate.

24. The scanner of claim 18, wherein the core is polycarbonate.
